(19) United States
(12) Patent Application Publication
(10) Pub. No.: US 2016/0343053 A1
(43) Pub. Date: Nov. 24, 2016

(54) Book exchange platform, system and method for an electronic device

(71) Applicant: Christopher Taylor Scott Domey, Morristown, NJ (US)

(72) Inventor: Christopher Taylor Scott Domey, Morristown, NJ (US)

(21) Appl. No.: 14/545,575

(22) Filed: May 21, 2015

(51) Int. Cl. G06Q 30/06; H04W 4/02; G01S 19/13; H04L 29/08; G06Q 50/00

(52) U.S. Cl. CPC G06Q 30/0625; H04L 67/306; H04L 67/18; H04L 67/02; G06Q 30/0635; G06Q 30/0639; G06Q 50/01; G01S 19/13; H04W 4/02

(57) ABSTRACT

A social media book exchange platform, system and method, for an electronic device executing an app comprises a server for reading medium and storing user information and book lists within the platform to provide a book swapping and selling app. The app has registration capability wherein a user can register on the electronic device setting-up a user account and login to the app as a registered user. The app having preferences for entering books the user is selling and entering books the user is interested in searching within the app. The app includes geographical input selection, wherein the user is prompted to select geographical radii wherein the book is posted for sale or swap within the app. A match alert is provided, wherein the match alert notifies the user when there is a match of the book being sold or swapped and the book being searched.

### FIELD OF THE INVENTION

The present invention relates to a platform for the electronic exchange and/or sale of goods and/or services; and more particularly to a platform supporting a system and method for digitizing, processing and transmitting information relating to the exchange and/or sale of goods and/or services.

### DESCRIPTION OF RELATED ART

Educational institution text books are costly. Many students have to expend large sums of money to purchase required text books for each of their classes. Book stores on University, College and/or school campuses offer the text books for sale at often exorbitant prices as “new” text books, with a slight reduction in price for “used” books. Meanwhile, these same “used” textbooks are bought-back from students for a modicum of the sale price. In today's society, especially among college aged adults, mobile social media has become very popular utilizing a combination of mobile devices executing social media applications.

Some examples of electronic applications directed to social media uses for goods/services transactions can be found below:

U.S. Pat. No. 5,878,416 to Harris, et al. discloses an automated system for matching an item of business property to a recipient including an inventory database containing inventory data concerning the item. A match module is coupled to the inventory database and receives allocation data for the item. The match module generates match data for the item and associates the match data with the inventory data. The match module receives an item request containing request data and matches the item to the recipient associated with the item request using the match data.

U.S. Pat. No. 6,058,417 to Hess, et al. discloses a method and apparatus for information presentation and management in an online trading environment. According to one aspect of the invention, person-to-person commerce over the Internet is facilitated by providing prospective buyers the ability to quickly preview items for sale. Images are harvested from a plurality of sites based upon user-supplied information. The user-supplied information includes descriptions of items for sale and locations from which images that are to be associated with the items can be retrieved. Thumbnail images are created corresponding to the harvested images and are aggregated onto a web page for presentation at a remote site. According to another aspect of the present invention, a user may submit a query to preview items for sale. After receiving the query, thumbnail images corresponding to items that satisfy the user query are displayed, each of the thumbnail images previously having been created based upon a user-specified image.

U.S. Pat. No. 6,131,087 to Luke, et al. discloses a computer implemented method for market participants for automatically identifying and matching offer data with solicitation data. The solicitation data is stored in a solicitations data base; the method comprises the steps of: receiving offer data consisting of numerical linear ranges defining a lower point, an upper point, and a preferred point for each dimension of the offer data storing the received offer data in a database; comparing points for each dimension of the stored offer data to corresponding dimensions of the solicitation data to: identify solicitations with matching preferred points, identify solicitations with preferred points having a near match with the offer data when the upper point and the preferred point of the offer data are between the upper point and the preferred point of the solicitation data, and identify solicitations with preferred points within corresponding ranges to the offer data when at least one of the lower point, the upper point, and the preferred point of the offer data is between the lower point and the upper point of the solicitation data; transmitting the identified solicitations with matching preferred points, near matching preferred points, and preferred points within corresponding ranges to originator of the offer data.

U.S. Pat. No. 6,847,938 to Moore discloses a method and system for coordinating the exchange of goods between parties over a communications network such as the Internet. Users of the system can interact with a central computer to input data regarding items that they offer for exchange, as well as search criteria describing items that they would like to receive in exchange. A processor in the central computer searches records stored in a database to find and sort those records that satisfy the user's search criteria. A second test is then performed to determine whether the information that the user input describing the item offered for exchange satisfies search criteria within the record. As a result, a match may be generated between two users who have input complementary criteria. The invention can also accommodate more complex exchanges between three or more parties.

U.S. Pat. No. 6,901,376 to Sculler, et al. discloses a computer-implemented method and system which retrieves interrelated agreements between the buyers and sellers of products and/or services. In one implementation, the products are personalized, and the personalization information is passed up the chain of distribution.

U.S. Pat. No. 7,024,391 to Burich discloses a member accessible information system for managing member information, and selectively providing member information to individual members. The members, typically belong to a common industry, such as the food industry and connect through remotely connected networked computers, such as over the Internet. Members may be food industry members including suppliers, manufacturers and customers, each accessing information supplied by members and maintained by the system. Members may search through previously authorized member provided information. The system includes a central storage which may be located on a database server and which stores product information, e.g., food product information and specifications. Members access the system through a web server. A security policy server verifies what product information and which specifications are to be available to each member. Specifications may be stored centrally or, distributed to member locations. An app server stores and selectively executes applications used by members. User security profiles are stored on and managed by a policy server. Each member's security profile indicates the level of authorization of the corresponding member. A personalization server may be included to record user member characteristics, i.e., content viewed by the member, and personalizes content to subsequently automatically make similar content available to the member. An ad server may be included to schedule, serve and track advertising content provided to members. Orders may be generated and placed automatically. Member use may be tracked to generate member bills automatically and bill individual members.

U.S. Pat. No. 7,058,602 to La Mura, et al. discloses an auction system and method for suitable use with online transactions which provide a plurality of enhanced auctions. The auction system extends, augments or otherwise enhances various auction elements including, for example, the selection of participants, the grouping of participants, the moves made by participants, the bidding process of participants, the information revelation process, the auction closing process, and the auction clearing process, among others. In addition, enhanced auction modules may be used separately or together during the auction process

U.S. Pat. No. 7,133,847 to Himmelstein discloses a bartering system that implements barters between a plurality of parties each having one or more classes of items available for barter. Preferably, barter orders are created by designating a selected quantity of a first class of items to be bartered, designating a date range for transferring title of the first class items to be bartered, designating a barter value of the first class of items to be bartered, and designating a second class of items to be acquired. Barter orders are posted via the Internet to a barter database and may be displayed via the Internet. Posted barter orders whose first class of items matches the second class of items of a barterer's order are preferably displayed. Posted barter orders from the display are selected to effectuate a barter transaction which combines a barterer's barter order with the selected posted order(s).

U.S. Pat. No. 7,877,315 to Pickering discloses a system and method for an on-line swapping service. The service registers members and allows members to list items that each member is willing to swap in exchange for credits with the service for an item from listed by another member. An example of the items that may be swapped using the swapping service is books, such as paperback books. To facilitate delivery through the mail of an item from one member to another member, a printable mailing wrapper is created by the system with the appropriate destination address. The system emails, downloads or otherwise sends the mailing wrapper to the member who is in position of the item to be shipped. That member simply prints the mailing wrapper on a standard printer, and wraps it around the item to be shipped via standard postal services

U.S. Patent App. Pub. No. 20020077925 to Fujita discloses a business system that the trader buys secondhand books and sells them again using the network of convenience stores. The trader establishes the main server on Internet and also opens the homepage on the Web site. The trader makes contracts concerning buying and hand-over business of secondhand books with convenience stores. This system features that the payment of the second hand book is accepted at the convenient store or card payment is available for the order on Web site

U.S. Patent App. Pub. No. 20050131797 to Ananthanarayanan, et al. discloses a method, system and computer program product for increasing the trading efficiencies for trading parties in an online market. The present invention couples the bilateral negotiations with the existing trading mechanisms. A buyer or seller in an online market can selectively execute the trading mechanism or invoke bilateral negotiations in order to arrive at attractive and feasibility of the trading deals. An alternate embodiment of the present invention provides method system and a computer program product for increasing the trading efficiency of the online market. The online market is regulated in order to maximize the number of trading parties that are able to strike trading deals within the regulations of the online market

U.S. Patent App. Pub. No. 20040059659 to Safaei, et al. discloses a computer-implemented method for processing lottery sales data comprising: assigning unique identifiers to a plurality of lottery retailers, where the unique identifiers indicate types of lottery games sold by respective lottery retailers from the plurality of lottery retailers; and identifying on a map display on a computer using the unique identifiers respective locations of lottery retailers from the plurality of lottery retailers. In some embodiments, a computer-implemented method for processing lottery sales data comprises: identifying on a map display on a computer a location of at least one lottery retailer from a plurality of lottery retailers; and identifying on said map display lottery sales data respective to the at least one lottery retailer representative of lottery sales by said at least one lottery retailer for a selected period of time.

U.S. Patent App. Pub. No. 20040068462 to Katz, et al. discloses a decentralized method of negotiating for the exchange of products over a communications network that can include generating a request specifying at least one product attribute within a requesting device and forwarding the request to other authorized devices having a presence on the communications network. Each of the devices can include a distributed search engine for locating descriptions of products stored in the devices which match the request. One or more descriptions of products matching the request can be received from selected ones of the authorized devices. The matching descriptions can be stored within the requesting device

U.S. Patent App. Pub. No. 20070124228 to Elias, et al. discloses an electronic bartering system and method for facilitating a trade of a first item owned by a first user for a second item owned by a second user when the first user and the second user are connected to a network. The electronic bartering system and method receives a request from the first user, allows the second user to access items owned by the first user, receives a response from the second user, and receives an acceptance from the first user The request identifies the second item and is a potential trade request. The response identifies the first item and is a trade offer The trade comprises the potential trade request, the trade offer, and the acceptance. Completion of the trade further includes receiving a confirmation from both the first user and the second user

Foreign Patent App. Pub. No. WO/2007/085661 to Deplanque discloses an information processing system and method to a corresponding computer program and to a corresponding computer-readable storage medium, which can e.g. especially be used for facilitating in a simple manner access to context-related information that relates to correspondingly characterized terms, articles or other contents in books or other printed products. The system comprises at least one printed product, at least one data processing device, means for data storage and means for data input and/or output. The at least one printed product has marking means and the marking means are associated with respective data stored in the data storage means. The system also comprises at least one sensor for detecting marking means and is configured in such a manner that data associated with the marking means are updated depending on the detection of marking means and/or that data and/or information exchange between users of the information processing system is facilitated

Non Patent Literature entitled “Trade Books with Our Online Book Swapping Club . . . ” found at http://www.paperbackswap.com/index.php discloses an online book swapping club. The literature teaches that club members can list books they would like to swap with other club members and mail same to a club member upon a matching request.

Non Patent Literature entitled “BookMooch” found at http://bookmooch.com/ discloses an online book swapping platform wherein a user lists books he/she wants to give away, and upon receipt of a request, mails a requested book to another user.

Non Patent Literature entitled “Book Swap” found at https://bookswap.northwestern.edu/ discloses an online book swapping site for North Western University. The BookSwap site connects Northwestern students with other students at Northwestern to help them save money on textbooks. Upon determining to buy a book from another student, the student logs onto the site and starts a conversation with the seller to arrange details on how to conclude the sales transaction.

Though various online book sale and/or exchange platforms have been provided in the art, there remain disadvantages in the art resulting from the inability to extend a search for a swap outside of a specific University, while at the same time providing a pin-pointed geographical range to facilitate a business transaction. Accordingly, there persists a need for an online book exchange and/or sale system and method wherein a user can designate his/her own unique search area or range. Therefore, it is an object of the present disclosure to obviate the disadvantages from the existing art and to provide a digital application system and method adapted to assist a user/student interested in selling or swapping text books with another user/student interested in locating a text book at an affordable price or swapping his/her text book based on personal input criteria.

### SUMMARY OF THE INVENTION

The present invention provides a method, system and apparatus for a book exchange platform for an electronic device/mobile device, particularly adapted to be utilized as an app on a mobile device when traveling. Contemplated mobile devices include devices such as, but not limited to, smart phones, laptops or tablets; however, the app can also be utilized on desk-top devices. The subject book exchange platform provides a digital application system and method adapted to assist a user/student interested in selling or swapping text books with another user/student interested in locating a text book at an affordable price or swapping his/her text book. A book exchange platform app is provided in communication with the book exchange platform so that the App can readily be downloaded and executed on a mobile device, which can have linkage to a desktop or non-mobile device. Mobile devices include Smart-phones, cellular phones, mobile digital tablets, and any other digital mobile device.

The subject technology provides a platform, app and method providing a website or app appointed for use by students and others. Participants in book exchange platform subscribe for a preselected period of time (a semester or full year, etc). Students would be able to list any book they wish to sell, or to which they desire access, or wish to purchase or swap. Once matched, the buyers and sellers would make arrangements on their own. The subject book exchange platform preferably does not handle the sales transaction or hold inventory; but would instead put buyers and sellers in touch with each other. A mobile messaging structure is utilized by the platform that communicates with a Smartphone, tablet or mobile device, or stationary device, having Internet connectivity and GPS technology, to display a mobile icon.

It provides a self-contained program or piece of software designed to fulfill the purpose of connecting users who have downloaded the book exchange program to a mobile device, tablet, laptop, or/and desk top. Preferred embodiments of the book exchange platform include restricting the database to textbooks from a given college, or correlating matches within preselected distances, e.g. 5-mile, 10-mile, or 20 mile radii.

In a broad embodiment the subject book exchange platform technology provides a platform, app and method of use, generally comprising: a) a server provided for reading medium and storing user information and book lists within a platform to provide a book swapping and selling app, said server communicating through an Internet with at least one electronic device having Internet access operated by a user; b) said app operable on said electronic device; c) said app having registration capability wherein a user can register on said electronic device setting-up a user account and login to said app; d) said app having preferences for entering books said user is selling or interested in selling, and entering books said user is interested in locating within said app; and e) geographical input means for designating a geographical area wherein said book exchange technology is operative, whereby said user is prompted to select a geographical radii wherein said book is posted for sale or swap within said app.

In another embodiment there is provided a social media book exchange platform operable on an electronic device, comprising a server for reading medium and storing user information and book lists within the platform to provide a book swapping and selling app. The server communicates through an Internet with at least one electronic device having Internet access operated by a user. Registration entry is provided wherein a user can register on the electronic device setting-up a user account and login to the app as a registered user. User preference entry is provided for entering books the user is selling and entering books the user is interested in searching within the app. Geographical input selection and location input entry are provided, wherein the user is prompted to select geographical radii in relation to the location input entry wherein the book is posted for sale or swap. Match alert is provided, wherein the match alert notifies each users of a transaction match when there is a match of the book being sold or swapped and the book being searched.

### BRIEF DESCRIPTION OF THE DRAWINGS

The advantages and features of the present disclosure will become better understood with reference to the detailed description taken in conjunction with the accompanying drawings, wherein like elements are identified with like symbols, and in which:

FIG. 1 illustrates an overview of the book exchange platform, system and method, for an electronic device;

FIG. 2a illustrates a block diagram of an embodiment of the subject book exchange platform for providing transmission, data access, interaction and execution of the platform software across a network, in accordance with an embodiment of the present disclosure;

FIG. 2b illustrates a continuation of the block diagram of FIG. 2a, showing execute find, and notification: book found;

FIG. 2c illustrates a continuation of the block diagram of FIG. 2b, showing user owner notification;

FIG. 3 illustrates a plan view of an embodiment of the book exchange platform, system and method, wherein a match is found within specified geographical area; and

FIG. 4 illustrates a plan view of another embodiment of the book exchange platform, system and method, wherein a match is found within specified geographical area.

### DETAILED DESCRIPTION OF THE DISCLOSURE

The best mode for carrying out the present disclosure is presented in terms of the embodiment, herein depicted in the Figures. The embodiment(s) described herein detail for illustrative purposes and may be subject to many variations. It is understood that various omissions and substitutions of equivalents are contemplated as circumstances may suggest or render expedient, but are intended to cover the application or implementation without departing from the spirit or scope of the present disclosure. Further, it is to be understood that the phraseology and terminology employed herein are for the purpose of the description and should not be regarded as limiting. Any headings utilized within description are for convenience only and have no legal or limiting effect.

The terms “a” and “an” herein do not denote a limitation of quantity, but rather denote the presence of at least one of the referenced item.

The subject invention provides a system and method for a social media book exchange and sale platform for an electronic device, particularly, but not limited to, a mobile device. The book exchange platform, system and method, for an electronic device, is directed to a mobile platform method for supporting Internet messaging systems. More particularly, it provides a website or app appointed for use by students and others. Participants in book exchange platform subscribe for a preselected period of time (a semester or full year, etc). Students are able to list any book they wish to sell, or to which they desire access or wish to purchase or swap. Once matched, the buyers and sellers can make arrangements on their own. The subject book exchange platform preferably does not handle the sales transaction or hold inventory; but instead puts buyers and sellers in touch with each other. A mobile messaging structure is utilized by the platform that communicates with a Smartphone, tablet or mobile device, or stationary device, having Internet connectivity and GPS technology, to display a mobile icon. It provides a self-contained program or piece of software designed to fulfill the purpose of connecting users who have downloaded the book exchange program to a mobile device, tablet, laptop, or/and desk top. Preferred embodiments of the book exchange platform include restricting the database to textbooks from a given college, or correlating matches within preselected distances, e.g. 5-mile, 10-mile, or 20 mile radii.

The subject book exchange platform provides a digital application system and method adapted to assist a user/student interested in selling or swapping text books with another user/student interested in locating a text book at an affordable price or swapping his/her text book. A book exchange platform app is provided in communication with the book exchange platform so that the App can readily be downloaded and executed on a mobile device, which can have linkage to a desktop or non-mobile device. Mobile devices include Smart-phones, cellular phones, mobile digital tablets, and any other digital mobile device.

In a first embodiment, a social media book exchange platform for an electronic device is provided comprising a server for reading medium and storing user information and book lists within the platform to provide a book swapping and selling app. The server communicates through an Internet with at least one electronic device having Internet access operated by a user. The app is operable on the electronic device and has registration capability wherein a user can register on the electronic device setting-up a user account and login to the app as a registered user. The app includes preferences for entering books the user is selling and entering books the user is interested in searching within the app. Geographical input selection is provided wherein the user is prompted to select geographical radii wherein the book is posted for sale or swap within the app. Match alert is provided wherein the match alert notifies the user when there is a match of the book being sold or swapped and the book being searched.

In a preferred embodiment, the platform further includes an Internet website and a user can utilize the website so that both registered and non-registered users can utilize the platform.

Preferably, the geographical radius comprises an input location and the geographical radii, including location of the electronic device. Wherein the electronic device is a mobile phone having GPS location means, the input location may be selected as the electronic device location as determined through the GPS. A location run selection entry may be provided wherein the user can select when GPS location means are activated or run in order to conserve battery power. In an alternative embodiment the location run selection entry by the user comprises election to run at a specific time of day for automatic location determination. For example, the user may select that the GPS location be run in the morning, afternoon, and/or in the evening. The platform may include a location run selection entry by the user for setting when GPS location means are activated or run, comprising an activation link so the user can activate manually. The input location may comprise a fixed address location, such as a home, dorm or business address where the user spends time. Alternatively, an input location may be provided as both an electronic device location determined by GPS and a fixed address location. The geographical radius may be set to a five (5) mile radius, ten (10) mile radius or a twenty (20) mile radius from the input location.

A subscription time entry may be provided wherein the registered user is adapted to subscribe for a preselected period of time on the platform. For example, the user can select to subscribe for a semester, six month time period, or a year. Additionally, preferably the platform provides for a sale selection means and a swap selection means. When the buyer has a book the seller is interested in, a swap match is created whereupon the users have the ability to select a swap rather than a sale.

When a match is found a match alert is generated to the matching users. The match alert may include an alert on the app whereupon each user sees the alert upon opening the app. Preferably, the user receives an alert by way of a text message or email message based on the user's preferences. Users can selection to meet in person, mail, or drop-off at a drop-off location when a match is found. A drop-off location box can be provided at specified locations. The drop-off box includes the ability for a seller or first user to insert the match book into the box within a set entry port and with the user's registered user information; when the buyer or second user enters his/her registered user information, he/she is prompted to either enter payment or insert a swap book (as determined between the parties transaction terms), and upon entry of same the book is dropped into a tray whereupon the user can take the book. The other user receives the money directly to his/her user account and/or can pick-up the money or swap book at a later time.

In another embodiment there is provided a social media book exchange platform operable on an electronic device, comprising a server provided for reading medium and storing user information and book lists within the platform to provide a book swapping and selling app. The server communicates through an Internet with at least one electronic device having Internet access operated by a user. Registration entry is provided wherein a user can register on the electronic device setting-up a user account and login to the app as a registered user. User preference entry is provided for entering books the user is selling and entering books the user is interested in searching within the app. Geographical input selection and location input entry is provided, wherein the user is prompted to select geographical radii in relation to the location input entry wherein the book is posted for sale or swap. Match alert is provided, wherein the match alert notifies each user of a transaction match when there is a match of the book being sold or swapped and the book being searched.

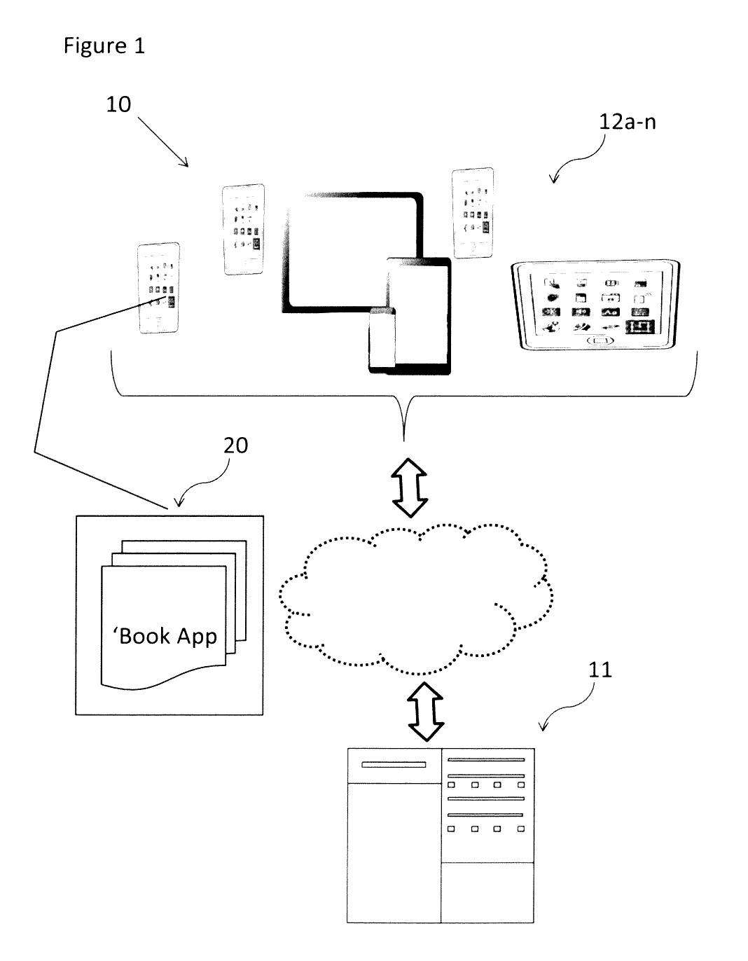

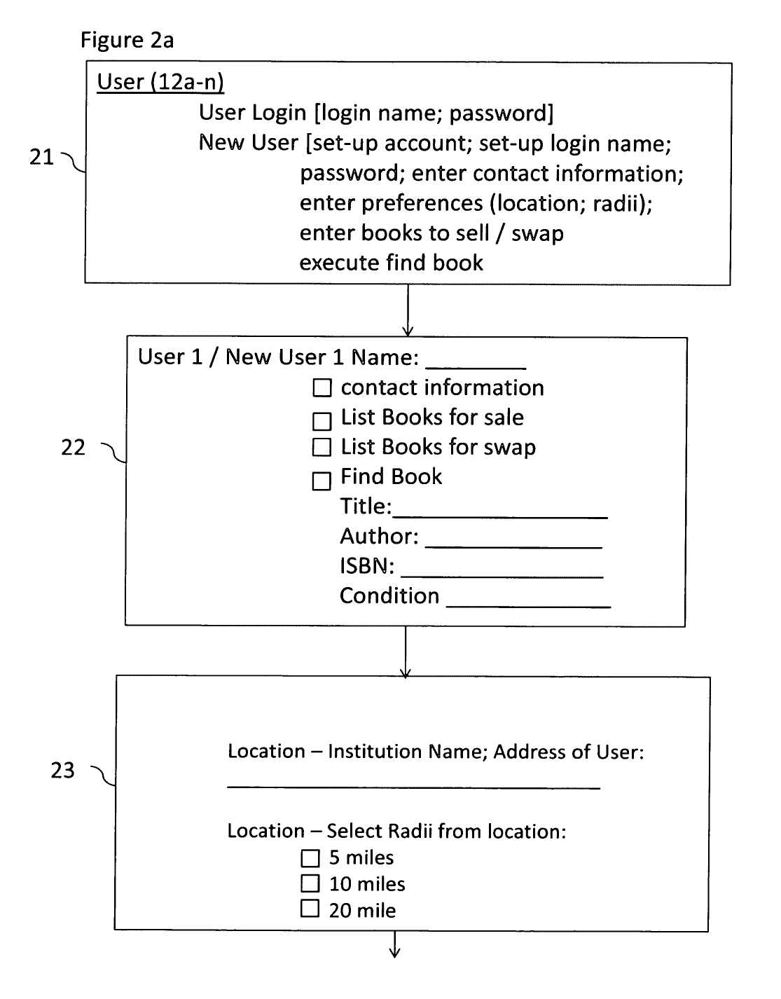

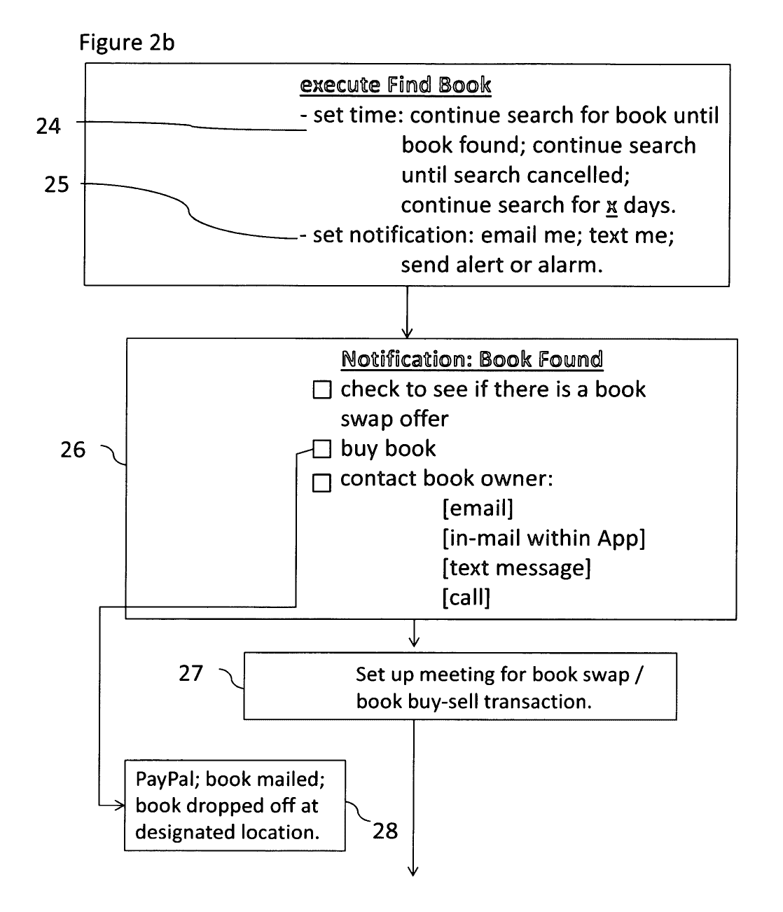

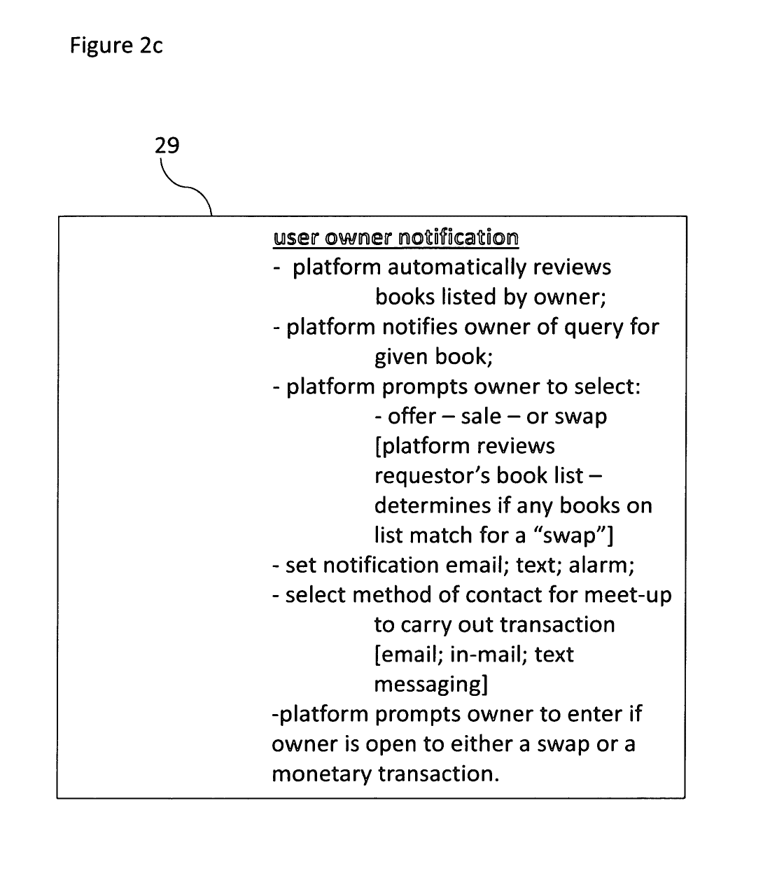

FIGS. 1-2c illustrate an embodiment of the subject book exchange platform, app and method of use. Referring to FIGS. 1-2c collectively, in operation, a user downloads the book exchange App on his/her mobile device, tablet, and/or desk-top and sets up a user account. The subject book exchange platform is generally shown at 10. A server 11 is provided for reading medium and storing user information and book lists within the book exchange platform. Server 11 communicates through the Internet with electronic devices having Internet access operated by student users 12a-n. Student users 12a-n can download the book exchange app 20 onto their mobile and/or desktop devices. After downloading the subject book exchange platform's software/application program onto a student user's 12a-n mobile device, a user can register on the device by setting-up a user account/or login to the app if the user already has an account, as shown at 21 in FIG. 2a.

After the user logs in or registers, the user can enter/modify his/her user preferences, such as contact information, select hyper-links for entering books he/she is selling/interested in swapping, select hyper-links for entering books he/she is interested in locating on the app, etc. as shown generally at 22 in FIG. 2a. The user also selects geographical inputs—such as for example, the name of the institution/college/university/school of choice by the user 12a-n, as well as the radii of search for user's in the app's book listing, as shown generally at 23 in FIG. 2a. GPS on each of the user's mobile device is activated briefly when the app is refreshed or executed to configure user's locations in relation to the radii of search fields entered by each user.

When a user executes to “Find Book”, the user enters information as to the book, such as at 22 in FIG. 2a. Upon executing “Find Book” the user can select different criteria, such as “set time” to set the time to continue the executed search for a given book, such as “until book found”, “continue search until search cancelled”, “continue search for x days”, wherein “x” is set as an integer preferably between 5 days up to 120 days, for example, as indicated at 24 in FIG. 2b. Set notification is also selected by the user—‘set notification: email me; text me; send alert or alarm”, as shown at 25 in FIG. 2b. Notification: Book Found if provided at 25 in FIG. 2b.

Notification selections may include for example: check to see if there is a book swap offer; buy book; contact book owner: [email] [in-mail within ‘BookSwap][text message][call], as shown at 26 in FIG. 2b. The parties can then set up meeting for book swap/book buy-sell transaction as indicated at 27 in FIG. 2b. Alternatively, the buyer can select to “buy book” and a third party financial transaction can take place, such as via PayPal, whereupon the book is mailed; book dropped off at designated location [book exchange platform drop box on campus, etc.], as shown at 28 in FIG. 2b. On the back-end, from the user/seller perspective, user owner notification is provided, as shown at 29 in FIG. 2c. An option is provided wherein the owner can provide the ability to either make a swap or a monetary transaction. User notification is executed wherein the platform automatically reviews books listed by owners on the server 11. The app notifies an owner/or owners of query for given book that the owner/owners have listed. The app/platform prompts the owner/owners to select:—offer—sale—or swap [platform reviews requestor's book list to determine if any books on list match buyer inquiry user's book list for a “swap”].

If more than one owner is located in the given radii for a potential sale, the buyer can select which owner to buy the book from/to swap a book with. Such decision for example, may be based on price, condition of the book, location of the buyer—seller, etc. The users can select communication method and notification method preferences. For example, the user can set notification of a customer/user interested in one of his/her books via notification via email; in-mail; text; alarm. The users can then select their method for carrying out the transaction:—select method of contact for meat-up to carry out transaction [email; in-mail; text messaging]; drop book and deposit money at a book exchange platform drop box location on campus, etc.

In summation, the book exchange platform, system and method involves a website or app appointed for use by students and others. Participants in the book exchange platform preferably subscribe for a preselected period of time (a semester or full year, etc). Students are able to list any book they wish to sell, or to which they desire access or wish to purchase. Once matched, preferably the buyers and sellers make arrangements on their own. The subject book exchange platform does not handle the sales transaction or hold inventory; but instead puts buyers and sellers in touch with each other. Preferred embodiments of the book exchange platform include restricting the database to textbooks from a given college, or correlating matches within preselected distances, e.g. 5-mile, 10-mile, or 20 mile radii.

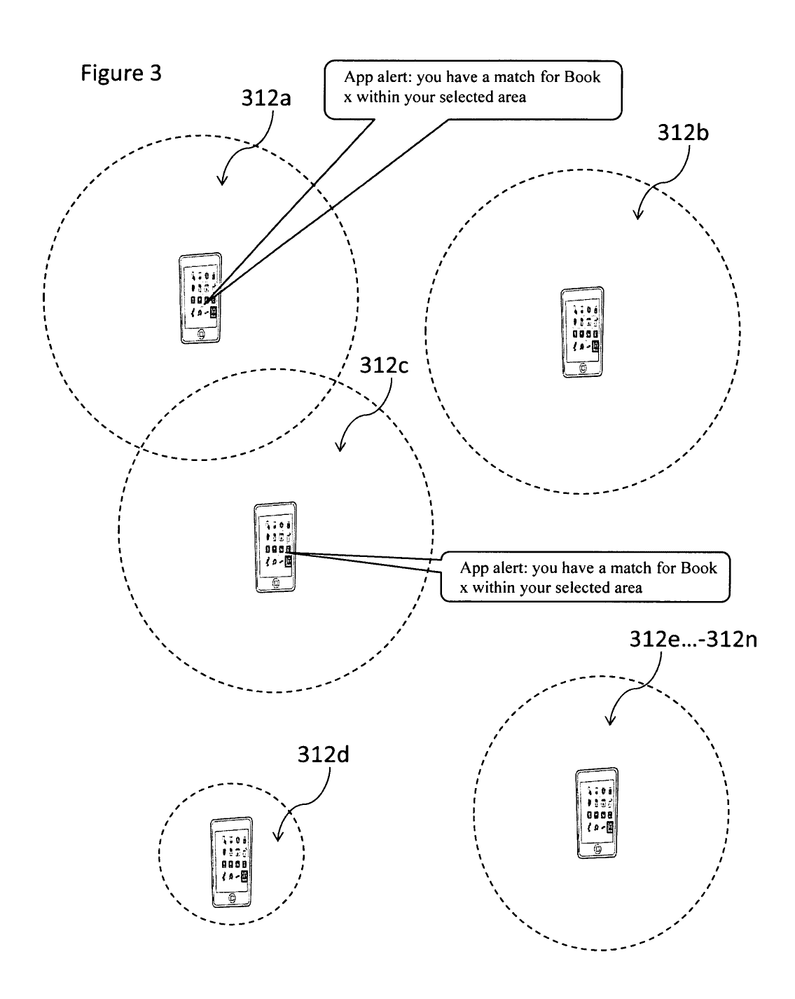

FIG. 3 illustrates a plan view of an embodiment of the book exchange platform, system and method, wherein a match is found within specified geographical area. The geographical radius for users 312a-312n (312a, 312b, 312c, 312d and 312e . . . 312n) is shown via phantom line circles. Each user enters input location, which herein are entered as each of the user's electronic devices—herein shown as mobile phones. Each geographical radius is selected by the user; preferably being 5 miles, 10 miles and/or 20 miles from the input location selection, which in this case is each of the user's electronic devices. Each of the electronic devices location is determined through the device's GPS. A location run selection entry may be provided wherein the users 312a-312n (312a, 312b, 312c, 312d and 312e . . . 312n) can select when GPS location means are activated or run, in order to conserve battery power. In an alternative embodiment the location run selection entry by the user comprises election to run at a specific time of day for automatic location determination. For example, the user may select that the GPS location be run in the morning, afternoon, and/or in the evening. The platform may include a location run selection entry by the user for setting when GPS location means are activated or run, comprising an activation link so the user can activate manually. When user's geographical radii overlap, the users are notified. If more than one overlap results, the users can select which of the buyers/sellers to conduct the book sale/swap transaction with.

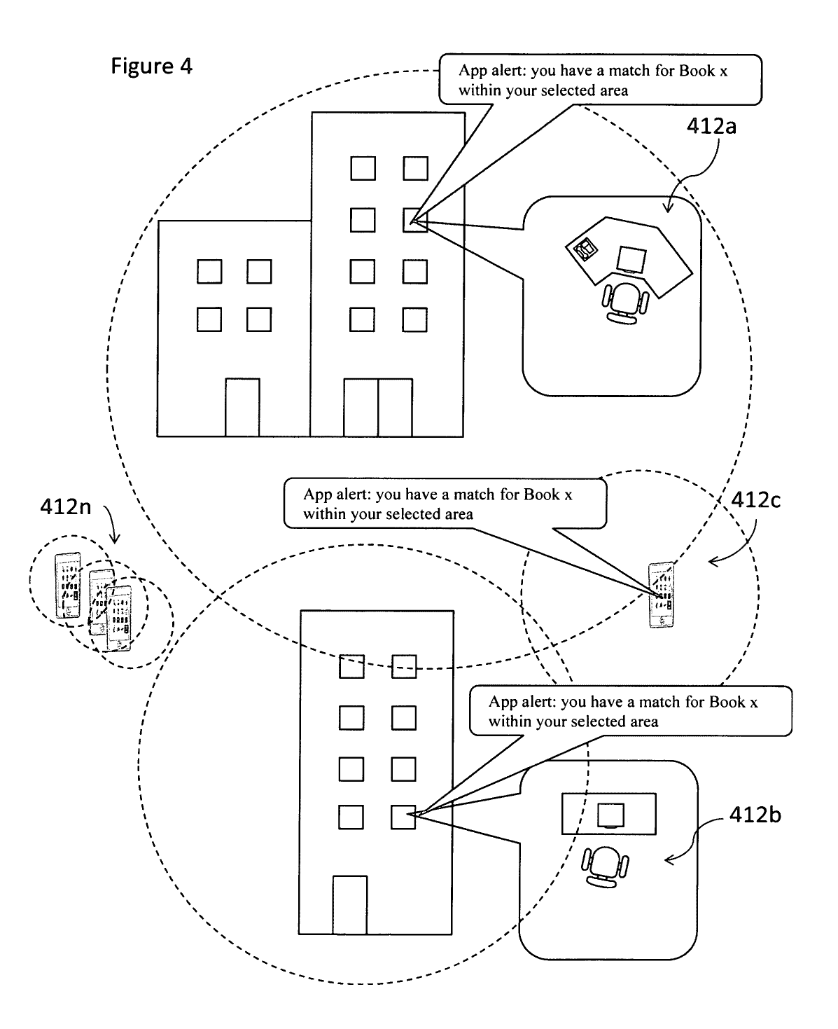

FIG. 4 illustrates a plan view of another embodiment of the book exchange platform, system and method, wherein a match is found within specified geographical area. In the figures shown, users 412a and 412b have selected the input location as a fixed address location, such as a home, dorm or business address where the user spends time; while users 412c-412n have selected their mobile device as the input location, which in turn is determined by GPS. When user's geographical radii overlap, the users are notified. If more than one overlap results, the users can select which of the buyers/sellers to conduct the book sale/swap transaction with.

The foregoing descriptions of specific embodiments of the present disclosure have been presented for purposes of illustration and description. Each of the platforms set forth can be modified for digital versions for an electronic device wherein software integrated within the platform performs the various tasks and computations. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated. These embodiments, as well as the modifications and variations thereof, are intended to fall within the scope of the invention, as defined by the subjoined claims

What is claimed is:

1. A social media book exchange platform for an electronic device, comprising:
a. a server for reading medium and storing user information and book lists within said platform to provide a book swapping and selling app operable on said electronic device, said server communicating through an Internet with at least one electronic device having Internet access operated by a user;
b. registration entry wherein a user can register on said electronic device setting-up a user account and login to said app as a registered user;
c. user preferences for entering books said user is selling and entering books said user is interested in searching within said app;
d. geographical input selection, wherein said user is prompted to select geographical radii wherein said book is posted for sale or swap within said app; and
e. match alert, wherein said match alert notifies said user when there is a match of said book being sold or swapped and said book being searched.

2. A social media book exchange platform as recited in claim 1, wherein said platform includes an Internet website and a user can utilize said website without being a registered user.

3. A social media book exchange platform as recited in claim 1, wherein said geographical radius comprises an input location and said geographical radii.

4. A social media book exchange platform as recited in claim 3, wherein said input location comprises location of said electronic device.

5. A social media book exchange platform as recited in claim 4, wherein said electronic device is a mobile phone having GPS location means, and wherein said location is determined through said GPS.

6. A social media book exchange platform as recited in claim 5, wherein said platform includes location run selection entry by said user for setting when GPS location means are activated or run.

7. A social media book exchange platform as recited in claim 6, wherein said location run selection entry by said user comprises election of specific time of day for automatic location determination.

8. A social media book exchange platform as recited in claim 5, wherein said platform includes location run selection entry by said user for setting when GPS location means are activated or run, comprising an activation link so said user can activate same manually.

9. A social media book exchange platform as recited in claim 3, wherein said input location comprises a fixed address location.

10. A social media book exchange platform as recited in claim 3, wherein said input location comprises location of said electronic device and a fixed address location.

11. A social media book exchange platform as recited in claim 3, wherein said geographical radius comprises a five (5) mile radii from said input location.

12. A social media book exchange platform as recited in claim 3, wherein said geographical radius comprises a ten (10) mile radii from said input location.

13. A social media book exchange platform as recited in claim 3, wherein said geographical radius comprises a twenty (20) mile radii from said input location.

14. A social media book exchange platform as recited in claim 1 comprising subscription time entry, wherein said registered user is adapted to subscribe for a preselected period of time on said platform.

15. A social media book exchange platform as recited in claim 1 comprising a sale selection means and a swap selection means.

16. A social media book exchange platform as recited in claim 1, wherein said match alert comprises a text message.

17. A social media book exchange platform as recited in claim 1, wherein said match alert comprises an email message.

18. A social media book exchange platform as recited in claim 1 comprising consummate sale or exchange, further comprising a selection to meet in person, mail, or drop-off at a drop-off location.

19. A social media book exchange platform as recited in claim 1 comprising a drop-off location box.

20. A social media book exchange platform operable on an electronic device, comprising:
a. a server provided for reading medium and storing user information and book lists within said platform to provide a book swapping and selling app, said server communicating through an Internet with at least one electronic device having Internet access operated by a user;
b. registration entry wherein a user can register on said electronic device setting-up a user account and login to said app as a registered user;
c. user preference entry for entering books said user is selling and entering books said user is interested in searching within said app;
d. geographical input selection and location input entry, wherein said user is prompted to select geographical radii in relation to said location input entry wherein said book is posted for sale or swap;
e. match alert, wherein said match alert notifies each users of a transaction match when there is a match of said book being sold or swapped and said book being searched.
